(19) United States
(12) Patent Application Publication
(10) Pub. No.: US 2005/0061267 A1
(43) Pub. Date: Mar. 24, 2005

(54) Check valve for diesel engine

(76) Inventor: Dae-Hun Cho, Gyeonggi-do (KR)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 10/749,204

(22) Filed: Dec. 30, 2003

(30) Foreign Application Priority Data
Sep. 23, 2003 (KR) 10-2003-0065810

(51) Int. Cl. F01P 1/04; F16K 21/04

(52) U.S. Cl. 123/41.35; 137/540

(57) ABSTRACT

A check valve for a diesel engine comprises a pipe formed with an oil inlet and oil outlet. A piston is slidably installed in the pipe and a spring pressures the piston toward the oil inlet side for closing an oil passage connecting the oil inlet and oil outlet. The spring is an asymmetric compression spring, which allows the compression length change of the spring to be relatively large at low oil pressure and slight at high oil pressure. Thereby, relatively increasing the oil jet change amount when the rpm of the diesel engine is low and decreasing the oil jet change amount when the rpm of the diesel engine is high. Thus reducing frictional loss of the engine oil pump and improving the fuel consumption rate.

### CROSS-REFERENCE TO RELATED APPLICATIONS

This application claims priority to Korean Application No. 10-2003-0065810, filed on Sep. 23, 2003, the disclosure of which is incorporated fully herein by reference.

### FIELD OF THE INVENTION

Generally, the present invention relates to a check valve for a diesel engine. More particularly, the check valve is adopted in a large diesel engine for adjusting the amount of oil injected for cooling a piston.

### BACKGROUND OF THE INVENTION

Typically, in large diesel engines oil is injected to a lower side of a piston for cooling the piston. Oil provided to a main oil gallery of the engine is injected through a check valve and an oil jet body to either the lower part of the piston or a piston gallery. The check valve typically remains in a closed state until it reaches a certain pressure.

A compression spring is generally used in the check valve for adjusting the oil jet amount. Accordingly, the area of the outlet of the check valve opening according to the pressure increase is linearly proportional to the pressure and the oil jet amount is also linearly proportional to the engine Revolutions Per Minute (RPM) and main gallery pressure.

There is a drawback in the conventional check valves in that excessive oil is provided to the valve at a high rpm, causing frictional loss in an engine oil pump and increase of fuel consumption.

### SUMMARY OF THE INVENTION

An embodiment of the present invention provides a check valve for a diesel engine adapted to relatively increase the oil jet change amount at a low rpm of the diesel engine and decrease the oil jet change amount at a high rpm of the diesel engine. Thereby, reducing frictional loss of the engine oil pump and improving the rate of fuel consumption.

In a preferred embodiment of the present invention, the check valve for a diesel engine comprises a pipe formed with an oil inlet and oil outlet. A piston is slidably installed in the pipe. A spring pressures the piston toward the oil inlet side for closing an oil passage connecting the oil inlet and oil outlet. The spring is an asymmetric compression spring designed to render the compression length change of the spring to be relatively large when low oil pressure is applied, and to be relatively slight when high oil pressure is applied.

### BRIEF DESCRIPTION OF THE DRAWINGS

For a better understanding of the nature and objects of the present invention, reference should be made to the following detailed description with the accompanying drawings, in which:

FIG. 1 is a schematic drawing of a check valve for a diesel engine according to an embodiment of the present invention.

### DETAILED DESCRIPTION OF PREFERRED EMBODIMENTS

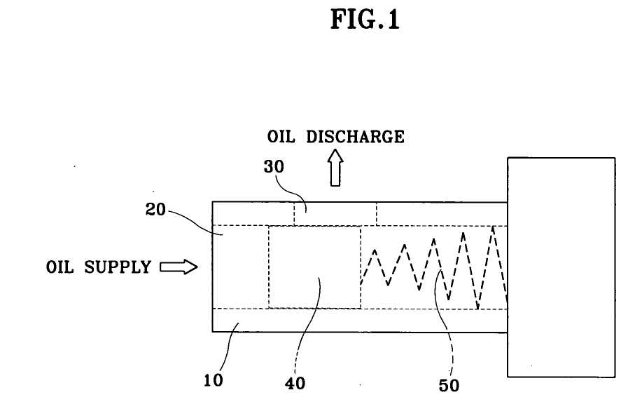

As shown in FIG. 1, a pipe 10 is formed with an oil inlet 20 and an oil outlet 30, wherein the oil inlet 20 is positioned perpendicularly to the oil outlet 30. A piston 40 is slidably installed in the pipe 10 and pressured via a spring 50 toward the oil inlet 20 for closing an oil passage connecting the oil inlet 20 and oil outlet 30. The spring 50 is an asymmetric compression spring, and the length of the spring 50 compressed according to the oil pressure applied to the oil inlet 20 refers to a logarithm functional change. The compression length change of the spring is relatively large when low oil pressure is applied, and slight when high oil pressure is applied. The asymmetric spring can be used by a spring getting smaller in diameter as it approaches one direction or a spring getting smaller in wire thickness as it approaches one direction.

The operation and effect of the check valve for a diesel engine will now be described. The oil pressure of the main oil gallery of the diesel engine is applied to the oil inlet 20. When the oil pressure presses the piston 40 into the pipe 10 by overcoming the elastic force of the spring 50, an oil passage is formed between the oil inlet 20 and oil outlet 30 for injecting the oil.

As the spring 50 is an asymmetric compression spring, the length of the spring 50 compressed according to the oil pressure applied to the oil inlet 20 refers to a logarithm functional change. Accordingly, the compression length change of the spring is relatively large in the area where the oil pressure is slightly applied, while the compression length change of the spring is relatively slight in the area where the oil pressure is applied largely.

When the rpm of the diesel engine is low, the area of the oil outlet 30 is largely changed in response to the oil pressure change to cause an relative increase of the oil jet change amount. On the other hand, when the rpm of the diesel engine is high, the area of the oil outlet 30 is slightly changed in response to the oil pressure change, thus the oil jet change is relatively reduced in amount.

As apparent from the foregoing, there is an advantage in the present invention in that the check valve for a diesel engine is adapted to relatively increase the oil jet change amount when the rpm of the diesel engine is low and decrease the oil jet change amount when the rpm of the diesel engine is high, contributing to a reduction of frictional loss of the engine oil pump and improvement of the fuel consumption rate.

1. A check valve for a diesel engine, comprising:
a pipe formed with an oil inlet and oil outlet;
a piston slidably installed in said pipe; and
a spring pressuring said piston toward said oil inlet for closing an oil passage connecting said oil inlet and oil outlet, wherein said spring is an asymmetric compression spring designed to render the compression length change of said spring to be relatively large when low oil pressure is applied and slight when high oil pressure is applied.

2. The valve as defined in claim 1, wherein said asymmetric compression spring is a spring getting smaller in diameter toward one direction.

3. The valve as defined in claim 1, wherein said asymmetric compression spring is a spring getting smaller in wire thickness toward one direction.
